(19) United States
(12) Patent Application Publication
(10) Pub. No.: US 2015/0250098 A1
(43) Pub. Date: Sep. 10, 2015

(54) Stalk Breaker for a Corn Head

(71) Applicant: Deere & Company, Moline, IL (US)

(72) Inventors: MICHAEL L. VANDEVEN, PRINCETON, IA (US); DUANE M. BOMLENY, GENESEO, IL (US); DANIEL M. HEIM, PORT BYRON, IL (US); BENJAMIN M. KELLER, REYNOLDS, IL (US)

(21) Appl. No.: 14/196,386

(22) Filed: Mar. 4, 2014

(51) Int. Cl. A01D 34/835

(52) U.S. Cl. CPC A01D 34/8355

(57) ABSTRACT

A stalk breaker (134, 134′) for a corn head (104) comprises a bracket (154, 154′) that is configured to be fixed to a corn head frame (106); a first spring (138, 138′) that has an upper end that is coupled to the bracket (154, 154′) and a lower end (166, 166′) that extends downwardly from the bracket (154, 154′); a second spring (140, 140′) that has an upper end that is coupled to the bracket (154, 154′) and a lower end (168, 168′) that extends downwardly from the bracket (154, 154′); and a paddle (136, 136′) that is generally planar and is supported on both of the lower ends of the two springs.

### FIELD OF THE INVENTION

The invention pertains to corn heads. More particularly, it relates to stalk breakers for corn heads.

### BACKGROUND

Combine harvesters harvest corn using corn heads. The corn heads are mounted on the front of the combine harvester and extend laterally and generally perpendicular to the direction of travel. The frame of the corn head extends laterally and supports several row units. Each row unit is configured to engage a row of corn plants.

When the corn head separates the corn from the corn plant, it leaves the lower part of the corn stalks (i.e. corn stobs) extending upward from the ground. The agricultural harvester is aligned with the corn rows. As a result, the tires of the combine harvester roll over the corn stobs in exactly the same position on the tires. This causes extreme tire wear and premature tire replacement due to deep grooves worn into the tire.

To solve this problem, “stalk breakers” are mounted behind the row units to break the stalks, bending them over and partially uprooting them before they reach the tires of the combine harvester.

U.S. Pat. No. 8,171,707, for example, discloses several long rollers supported at each end by beams pivotally coupled to the frame of the corn head. This arrangement is quite large and heavy.

US 2013/0061569, as another example, discloses a skid plate mounted to a mounting bracket, which in turn is connected to a single elongate spring strap. This arrangement is large, heavy, and requires considerable clearance.

What is needed, therefore, is an alternative stalk breaker that weighs substantially less and takes up less space. It is an object of this invention to provide such a stalk breaker.

### SUMMARY OF THE INVENTION

In accordance with a first aspect of the invention, a stalk breaker for a corn head is provided, comprising: a bracket configured to be fixed to a corn head frame; a first spring, that comprises an upper end that is coupled to the bracket, wherein the first spring also comprises a lower end that extends downwardly from the bracket; a second spring that comprises an upper end that is coupled to the bracket, wherein the second spring also comprises a lower end that extends downwardly from the bracket; and a paddle that is generally planar and is supported on the lower end of the first spring, and the lower end of the second spring.

Each of the first spring and the second spring may comprise a coiled spring section. The stalk breaker may comprise a member supported on the bracket about which member each coiled spring section may be coiled. The member may be generally cylindrical and may have two opposing ends. The two opposing ends of the member may be supported on the bracket. The paddle may have a first edge and a second edge opposite thereto, and the lower end of the first spring may be coupled to the paddle along the first edge, and the lower end of the second spring may be coupled to the paddle along the second edge. The paddle may be slidingly supported on the lower end of the first spring, and the paddle may be slidingly supported on the lower end of the second spring. The stalk breaker may further comprise a first bias spring and a second bias spring, wherein the first bias spring may be coupled between the paddle and the first spring to bias the paddle downward with respect to the first spring, and wherein the second bias spring may be coupled between the paddle and the second spring to bias the paddle downward with respect to the second spring. The lower end of the first spring maybe pivotally coupled to the first edge to pivot the paddle about a pivot axis with respect to the lower end of the first spring, and the lower end of the second spring may be pivotally coupled to the second edge to pivot the paddle about the pivot axis with respect to the lower end of the second spring. The pivot axis may extend generally horizontally and perpendicular to a direction of travel of the stalk breaker. The bracket may be configured to be mounted to a toolbar of the corn head, and further wherein the toolbar is configured to be fixed to and support a row unit of the corn head. The bracket may be configured to be fixed to a toolbar of the corn head frame. The first spring, the second spring, and the paddle may be disposed below the toolbar.

In accordance with another aspect of the invention, a corn head may comprise a corn head frame; a plurality of row units mounted on the corn head frame; and at least one stalk breaker in accordance with the first aspect of the invention that is mounted on the corn head frame.

### BRIEF DESCRIPTION OF THE DRAWINGS

FIG. 1 is a plan view of an agricultural combine with a corn head having stalk breakers in accordance with the present invention.

FIG. 2 is a bottom view of the corn head of FIG. 1.

FIG. 3 is a rear perspective view of a first embodiment of the stalk breaker of FIGS. 1-2.

FIG. 4 is a front perspective view of the stalk breaker of FIG. 3.

FIG. 5 is a cross-sectional view of the stalk breaker of FIGS. 3-4 taken at section line 5-5 in FIG. 4.

FIG. 6 is a cross-sectional view of the stalk breaker of FIGS. 3-4 taken at section line 6-6 in FIG. 4.

FIG. 7 is a rear perspective view of a second embodiment of the stalk breaker of FIGS. 1-2.

FIG. 8 is a front perspective view of the stalk breaker of FIG. 7.

FIG. 9 is a cross-sectional view of the stalk breaker of FIGS. 7-8 taken at section line 9-9 in FIG. 8.

FIG. 10 is a cross-sectional view of the stalk breaker of FIGS. 7-8 taken at section line 10-10 in FIG. 8.

### DETAILED DESCRIPTION

The term “front”, “forward” (or like terms) when used herein refers to a forward direction of travel “V” of the agricultural combine and the stalk breaker when traveling through the field harvesting crops. The term “rear”, “backward” (or like terms) when used herein refers to a direction of travel opposite to the forward direction of travel.

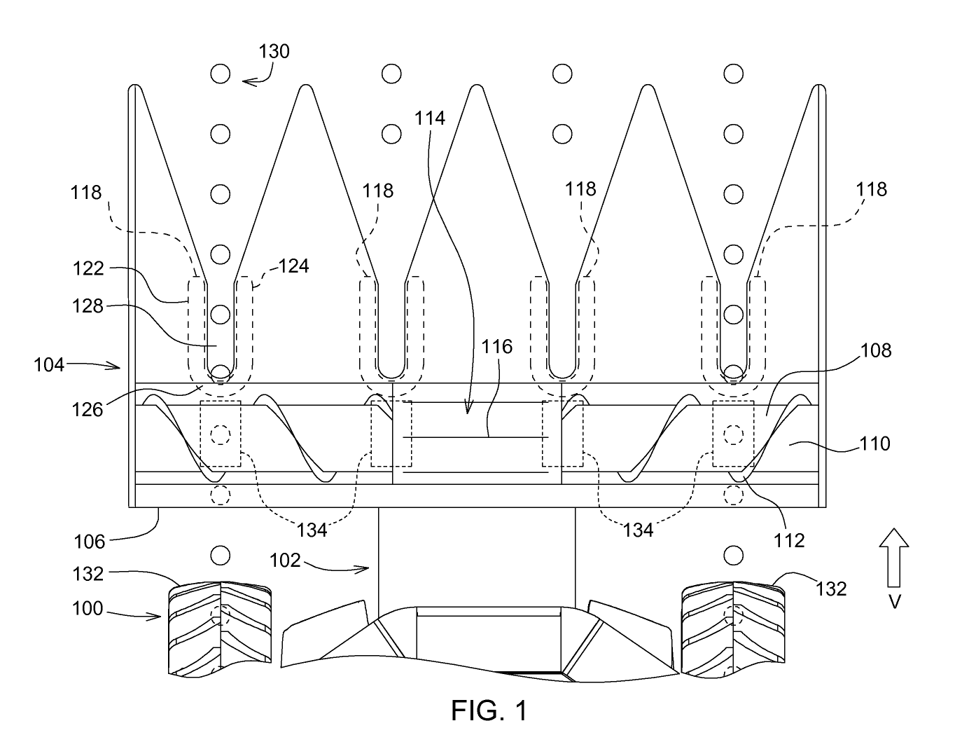

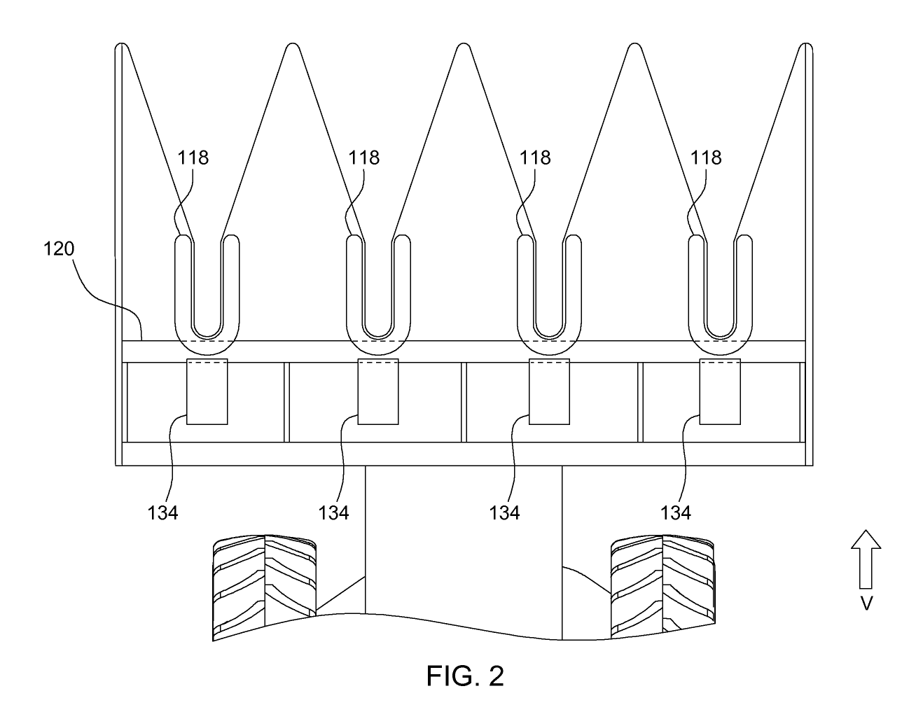

FIGS. 1 and 2 show a combine harvester vehicle 100 having a feederhouse 102 fixed to and extending from a forward end of the combine harvester vehicle 100, and also having a corn head 104 supported on the forward end of the feederhouse 102.

The corn head 104 comprises a corn head frame 106 that extends laterally and generally perpendicular to the forward direction of travel “V”. The corn head frame 106 supports a lateral conveyor 108. The lateral conveyor 108 is an auger conveyor comprising a laterally-extending cylinder 110 on which are fixed spiral flights 112.

A motor (not shown) is coupled to the cylinder 110 to rotate the cylinder thereby drawing cut crop material inward towards the central region 114 of the lateral conveyor 108. Laterally extending flights 116 are fixed to a central region of the cylinder 110 to draw cut crop material rearward and into the feederhouse 102. Cut crop material passing into the feederhouse 102 is carried rearward and into the combine harvester vehicle 100 for threshing, separating and cleaning.

The corn head 104 also comprises a plurality of row units 118 that are arranged in side-by-side relation and are fixed to a toolbar 120. Toolbar 120 extends laterally and substantially the entire width of the corn head 104 in a direction perpendicular to the direction of travel “V”.

Typically, all of the row units 118 are identical to each other. Each row unit 118 is in the form of a first forwardly extending arm 122 that extends forward in the direction of travel “V” on the left side of the row unit 118, and a second forwardly extending arm 124 that is generally parallel to the first forwardly extending arm 122. The two forwardly extending arms are joined at a gearbox 126 disposed at the rear of the row unit 118.

The first forwardly extending arm 122 and the second forwardly extending arm 124 define a gap 128 between them that is configured to receive a row of crop plants 130 as the combine harvester vehicle 100 travels to the field harvesting crops. The row unit 118 is configured to strip ears of corn from the corn stalk and to sever the corn stalk adjacent to the ground.

When the cornstalks are severed, the row units 118 leave a row of short cornstalks (also known as “stobs”) that extend generally vertically from the ground. The stobs, while not very strong individually, can cause severe damage over time to the tires 132 that support the combine harvester vehicle 100.

For this reason, the corn head 104 also comprises stalk breakers 134 that are fixed to the corn head 104 (and particularly the toolbar 120), extend downward therefrom, and break, bend, or uproot the stobs before the stobs reach the tires 132.

In this manner, e.g. by breaking, bending, or uprooting the stobs, the damage to the tires 132 is significantly reduced. Further, by breaking, bending, or uprooting the stobs, the decomposition of the stobs into the soil is encouraged. This decomposition enriches the soil.

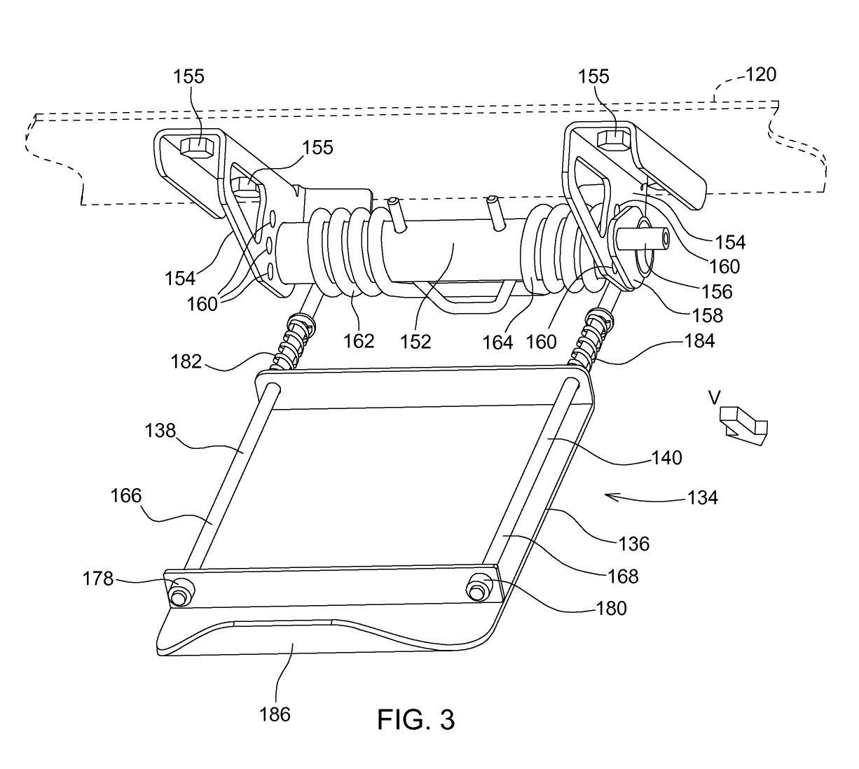

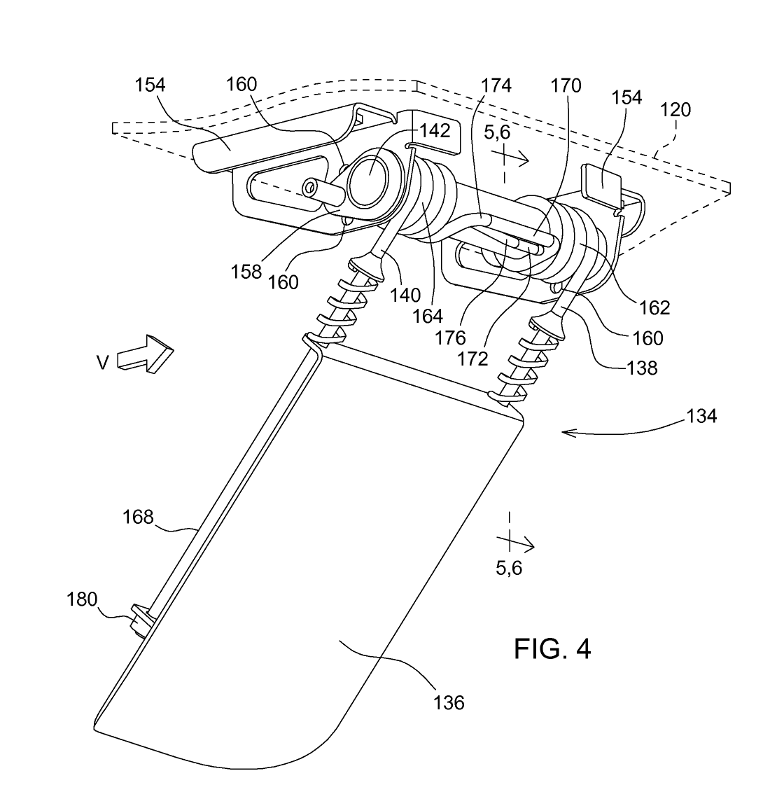

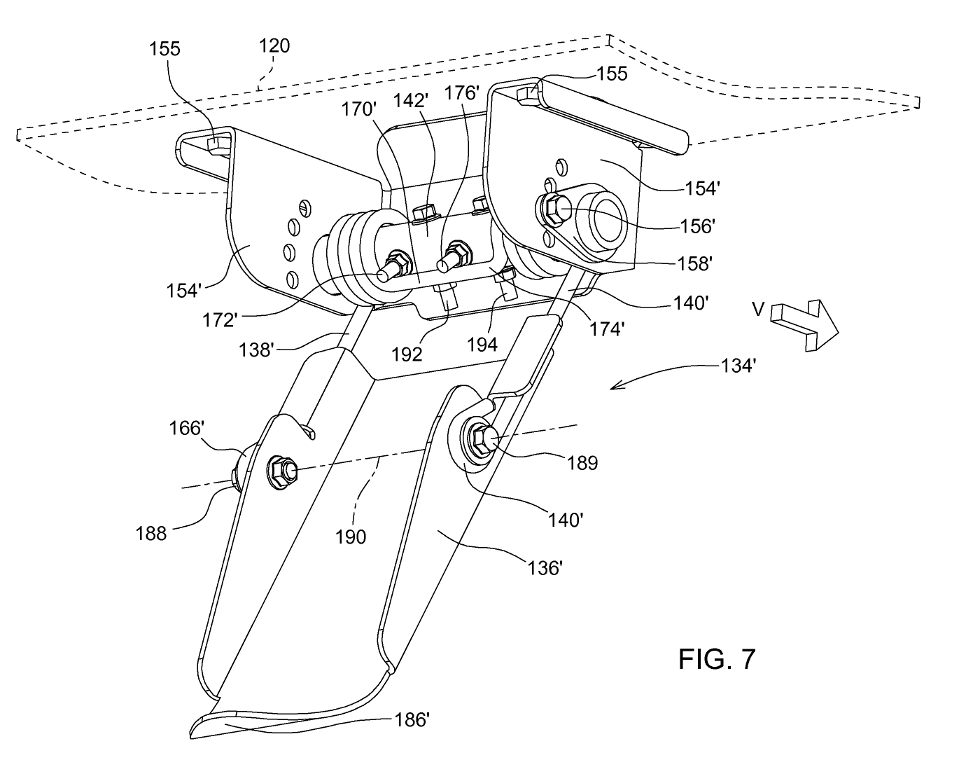

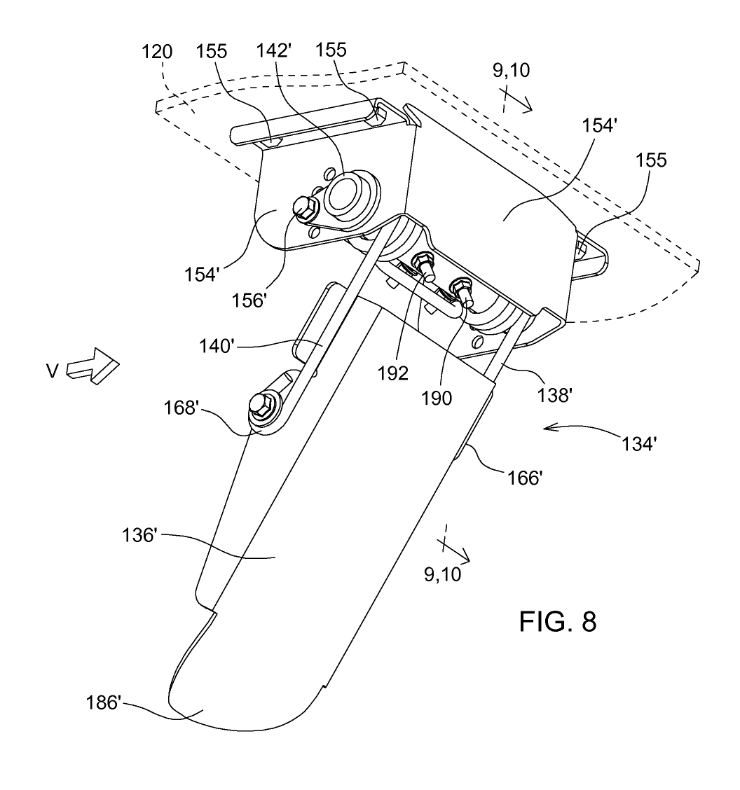

FIGS. 3-6 show a first embodiment of the stalk breaker 134. FIGS. 7-10 show a second embodiment of the stalk breaker 134. The second embodiment is identified in FIGS. 7-10 as 134′.

Referring now to FIGS. 3-6, stalk breaker 134 comprises a paddle 136 that is supported on a first spring 138 and a second spring 140. The paddle 136 is supported on a lower end of the first spring 138 and the second spring 140. The upper end of the first spring 138 and the second spring 140 is supported on a member 142, which in turn is supported on a bracket 154, which in turn is fixed to a lower portion of the toolbar 120 by removable fasteners 155.

The member 142 is in the form of an elongate cylinder that extends laterally and generally parallel to the toolbar 120. The member 142 is supported at both its opposing ends in apertures provided in the bracket 154. The member 142 can be pivoted in the apertures about its longitudinal axis to a plurality of different operating positions.

The member 142 is held in these different operating positions by a pin 156 that extends from a flange 158. The flange 158 is fixed (e.g. by welding) to an end of the member 142. The rotational position of the member 142 with respect to the bracket 154 can be changed by removing the pin, rotating the member 142, and reinserting the pin 156 into a corresponding hole 160 in the bracket 154. Several of these holes 160 are provided in the bracket 154 to hold the member 142 in several different alternative rotational positions with respect to the bracket 154.

The first spring 138 includes a first coiled spring section 162 and the second spring 140 includes a second coiled spring section 164. The first coiled spring section 162 and the second coiled spring section 154 are coiled around the member 142, thus securing the first spring 138 and the second spring 140 to the member 142. Enough clearance is provided between the first coiled spring section 162 and the second coiled spring section 164 to permit a lower end 166 of the first spring 138 and a lower end 168 of the second spring 140 to flex up and down as the stalk breaker 134 is dragged across the corn stubble extending upward from the field.

The first spring 138 has an upper end 170 that abuts a stop 172 on the member 142. As the member 142 is rotated with respect to the bracket 154, the position of the stop 172 changes as well. The stop 172 controls the position of the upper end 170. It therefore controls the spring preload and downforce of the first spring 138 against the paddle 136, and thus controls the preload and downforce of the paddle 136 against the ground.

The second spring 140 has an upper end 174 that abuts a stop 176 on the member 142. As the member 142 is rotated with respect to the bracket 154, the position of the stop 176 changes as well. The stop 176 controls a position of the upper end 174. It therefore controls the preload and downforce of the second spring 140 against the paddle 136, and thus controls the preloading downforce of the paddle 136 against the ground.

In the arrangement illustrated herein, the upper end 170 and the upper end 174 are fixed together for convenience. In another arrangement, the first spring 138 and the second spring 140 can be separate, individual components.

The paddle 136 is slidingly supported on the lower end 166 of the first spring 138 and the lower end 168 of the second spring 140. A stop 178 is fixed to the lower end 166 to prevent the paddle 138 from sliding off the lower end 166 of the first spring 138. A stop 180 is fixed to the lower in 168 to prevent the paddle 138 from sliding off the lower end 168 of the second spring 140.

A first bias spring 182 (coupled to and between the paddle 136 and the first spring 138) is provided to bias the paddle 136 downward and toward a lower end of the lower end 166. A second bias spring 184 (coupled to and between the paddle 136 and the second spring 140) is provided to bias the paddle downward toward a lower end of the lower end 168.

Both the first bias spring 182 and the second bias spring 184 permit the paddle 136 to slide upward with respect to the first spring 138 and the second spring 140. This upward sliding reduces the possibility of damage to the stalk breaker 134 when the combine harvester vehicle 100 is driven rearward (i.e. backward).

When the combine harvester vehicle 100 is driven backward, the ground, acting against the bottom 186 of the paddle 136, will cause the paddle 136 to slide upward along the lower end 166 and the lower end 168. When the combine harvester vehicle 100 is again driven in a forward direction, the first bias spring 182 and the second bias spring 184 will push the paddle 136 downward along the lower end 166 and the lower end 168. Stop 178 and stop 180 will prevent the paddle 136 from sliding off the lower end 166 and the lower end 168.

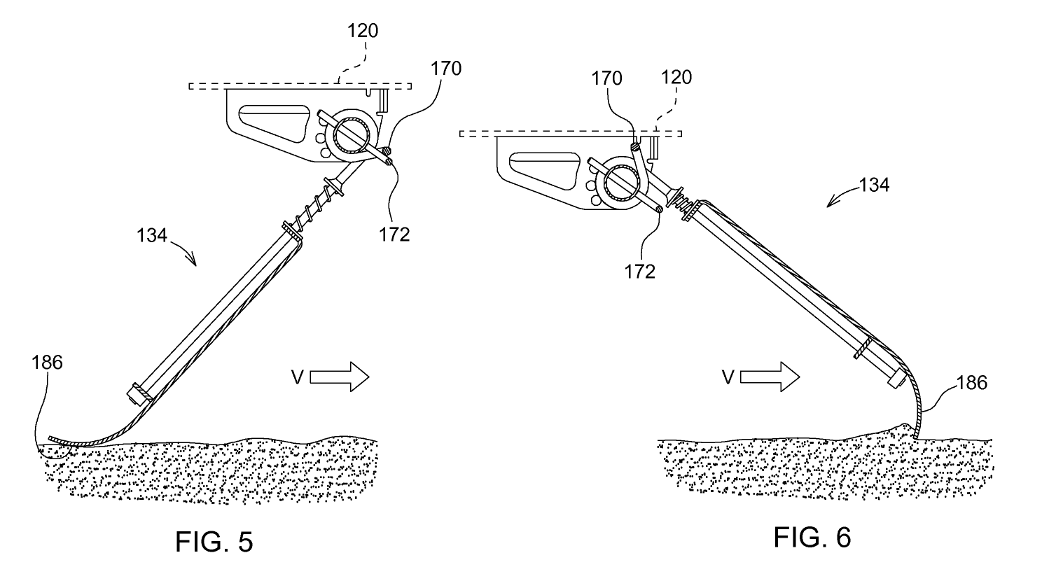

When the combine harvester vehicle 100 travels in a reverse direction, the paddle 136 is rotated forward from the position shown in FIG. 5 to the position shown in FIG. 6. This reverse movement of the paddle 136 lifts the upper end 170 (and the upper end 174, not shown) away from the stop 172 (and the stop 176, not shown). This permits the first coiled spring section 162 (and the second coiled spring section 164, identically arranged, but not shown) to rotate freely in the reverse direction and remain slack, and not tensioned in the reverse direction. This reduces the amount of gouging and digging the bottom 186 of the paddle 136 does against the ground when dragged in a reverse direction (see FIG. 6).

In FIGS. 5 and 6, the construction and operation of spring 138 is illustrated. Since the stalk breaker 134 is mirror symmetric about a vertical and longitudinal plane that passes through a lateral midpoint of the stalk breaker 134, the construction and operation of spring 140 is identical.

FIGS. 7, 8, 9, and 10 illustrate a second embodiment of a stalk breaker 134′ in which the paddle 136′is supported on a first spring 138′ and a second spring 140′. In the same manner as the embodiment of FIGS. 1-6, a bracket 154′ is fixed to the toolbar 120 by removable fasteners 155 and supports a member 142′. The member 142′ is similarly repositionable by removing a removable fastener 156′ (here shown as a threaded fastener) from a flange 158′, rotating the member 142′, and reinstalling the removable fasteners 156′. The first spring 138′ and the second spring 140′ similarly have a first coiled spring section 162′ and a second coiled spring section 164′ (respectively) that wrap around the member 142′. The first spring 138′ and the second spring 140′ similarly have upper ends 170′ and 174′ that abuts corresponding stops 172′ end 176′.

The lower end 166′ of the spring 138′, and the lower end 168′ of the spring 140′ are formed as eyes through which a pivot pin 188 and a pivot pin 189 respectively extend. The pivot pin 188 and the pivot pin 189 are fixed to the paddle 136′ such that the paddle 136′ can pivot with respect to the lower end 166′ and the lower end 168′ about an axis 190 defined by the eyes at the lower end 166′ and the lower end 168′. The axis one 90 is generally horizontal and extends parallel to the longitudinal extent of the toolbar 120.

A stop 192 and a stop 194 are fixed to the member 142′ to stop forward rotational motion of the upper ends of spring 138′ and the spring 140′ (respectively) with respect to the member 142′. In this manner, when the direction of travel of the combine harvester vehicle 100 changes from forward to reverse and the lower end 186′ is dragged forwardly by the ground with respect to the corn head frame 106, the upper ends of spring 138′ and the spring 140′ can rotate freely about the member 142′ from a first position in which they abut stop 172′ and stop 176′, to a second position in which they abut stop 192 and stop 194 (respectively).

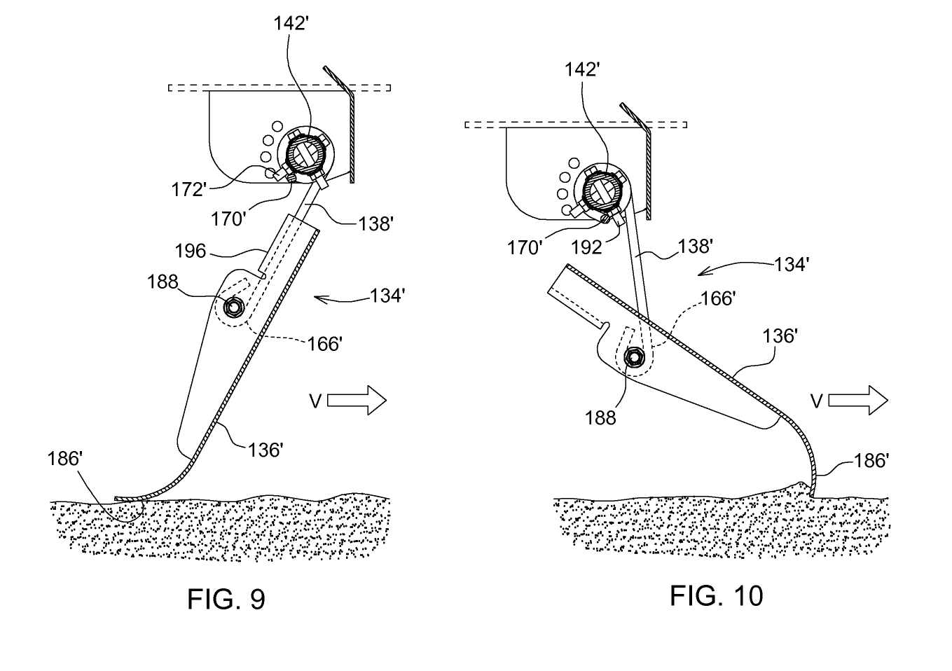

At the same time (i.e. when the direction of travel is reversed), the position of the paddle 136′ with respect to the spring 138′ and the spring 140′ also changes. FIG. 9 represents the position of the paddle 136′ with respect to the spring 138′ and the spring 140′ when the combine harvester vehicle 100 is traveling in a forward direction “V” harvesting crops. FIG. 10 represents the position of the paddle 136′ with respect to the spring 138′ and the spring 140′ when the combine harvester vehicle 100 is traveling in a reverse direction (i.e. a direction opposite the direction of travel “V”).

In FIG. 9, the paddle 136′ has pivoted rearward with respect to the spring 138′ until a stop 196 formed in the paddle 136′ abuts the lower end of the spring 138′. This prevents further rearward pivoting motion of the paddle 136′ with respect to the lower end of the spring 138′. Any further rearward motion of the paddle 136′ causes the spring 138′ to flex rearward. In this position, the upper end 170′ of the spring 138′ abuts the stop 172′ and prevents it from rotating further with respect to the member 142′.

In FIG. 10, the paddle 136′ has pivoted forwardly with respect to the spring 138 about the pivot axis one 90 and away from the stop 196. This releases the downward pressure of the spring 138′ against the ground and permits the lower end 186′ of the paddle 136′ to press lightly against the ground. At the same time, the spring 138 primus pivoted forwardly until its upper end 170′ abuts stop 192′, thus preventing further pivoting in a forward direction of the spring 138′ with respect to the member 142′.

In FIGS. 9 and 10, the construction and operation of spring 138′ is illustrated. The stalk breaker 134′ is mirror symmetric about a vertical and longitudinal plane that passes through a lateral midpoint of the stalk breaker 134′, therefore the construction and operation of spring 140′ is identical.

The figures and explanations herein illustrate two embodiments of the invention. The invention is not limited to the embodiments illustrated herein, however. To one skilled in the art of corn head design and operation, other embodiments of the invention are also possible.

I claim:

1. A stalk breaker (134, 134′) for a corn head (104) comprising:
a bracket (154, 154′) configured to be fixed to a corn head frame (106);
a first spring (138, 138′), that comprises an upper end that is coupled to the bracket (154, 154′), wherein the first spring (138, 138′) also comprises a lower end (166, 166′) that extends downwardly from the bracket (154, 154′);
a second spring (140, 140′) that comprises an upper end that is coupled to the bracket (154, 154′), wherein the second spring (140, 140′) also comprises a lower end (168, 168′) that extends downwardly from the bracket (154, 154′); and
a paddle (136, 136′) that is generally planar and is supported on the lower end (166, 166′) of the first spring (138, 138′), and the lower end (168, 168′) of the second spring (140, 140′).

2. The stalk breaker (134, 134′) of claim 1, wherein each of the first spring (138, 138′) and the second spring (140, 140′) comprises a coiled spring section (162, 162′, 164, 164′).

3. The stalk breaker (134, 134′) of claim 2, further comprising a member (142, 142′) supported on the bracket (154, 154′) and about which each coiled spring section (162, 162′, 164, 164′) is coiled.

4. The stalk breaker (134, 134′) of claim 3, wherein the member (142, 142′) is generally cylindrical and has two opposing ends.

5. The stalk breaker (134, 134′) of claim 4, wherein the two opposing ends of the member (142, 142′) are supported on the bracket (154, 154′).

6. The stalk breaker (134, 134′) of claim 1, wherein the paddle (136, 136′) a first edge and a second edge opposite thereto, and further wherein the lower end (166, 166′) of the first spring (138, 138′) is coupled to the paddle (136, 136′) along the first edge, and further wherein the lower end (168, 168′) of the second spring (140, 140′) is coupled to the paddle (136, 136′) along the second edge.

7. The stalk breaker (134, 134′) of claim 6, wherein the paddle (136, 136′) is slidingly supported on the lower end (166, 166′) of the first spring (138, 138′), and further wherein the paddle (136, 136′) is slidingly supported on the lower end (168, 168′) of the second spring (140, 140′).

8. The stalk breaker (134, 134′) of claim 7 further comprising a first bias spring (182) and a second bias spring (184), wherein the first bias spring (182) is coupled between the paddle (136) and the first spring (138) to bias the paddle (136) downward with respect to the first spring (138) and the second bias spring (184) is coupled between the paddle (136) and the second spring (140) to bias the paddle (136) downward with respect to the second spring (140).

9. The stalk breaker (134′) of claim 6 wherein the lower end (166′) of the first spring (138′) is pivotally coupled to the first edge to pivot the paddle (136′) about a pivot axis (190) with respect to the lower end (166′) of the first spring (138′), and further wherein the lower end (168′) of the second spring (140′) is pivotally coupled to the second edge to pivot the paddle (136′) about the pivot axis (190) with respect to the lower end (168′) of the second spring (140′).

10. The stalk breaker (134′) of claim 9, wherein the pivot axis (190) extends generally horizontally and perpendicular to a direction of travel (“V”) of the stalk breaker (134′).

11. The stalk breaker (134, 134′) of claim 1, wherein the bracket (154, 154′) is configured to be mounted to a toolbar (120) of the corn head (104), and further wherein the toolbar (120) is configured to be fixed to and support a row unit (118) of the corn head (104).

12. The stalk breaker (134, 134′) of claim 1, wherein the bracket (154, 154′) is configured to be fixed to a toolbar (120) of the corn head frame (106), and further wherein the first spring (138, 138′), the second spring (140, 140′), and the paddle (136, 136′) are disposed below the toolbar (120).

13. A corn head (104) comprising:
a corn head frame (106);
a plurality of row units (118) mounted on the corn head frame (106); and
at least one stalk breaker (134, 134′) in accordance with claim 1 that is mounted on the corn head frame (106).
